(19) United States
(12) Patent Application Publication
(10) Pub. No.: US 2004/0135702 A1
(43) Pub. Date: Jul. 15, 2004

(54) Universal vehicle remote control with feature selectable transmitter and associated methods

(75) Inventor: Kenneth E. Flick, Douglasville, GA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Omega Patents, L.L.C., Douglasville, GA

(21) Appl. No.: 10/336,079

(22) Filed: Jan. 3, 2003

(51) Int. Cl. G08C 19/00

(52) U.S. Cl. 340/825.72

(57) ABSTRACT

A method of providing a customer-selected remote control feature package in a vehicle may include installing in the vehicle a universal remote control device operable according to a plurality of different remote control feature packages, and negotiating a sale or lease of the vehicle with a customer. Negotiating a sale or lease of the vehicle may include offering the different remote control feature packages to the customer, and accepting an order for the customer-selected remote control feature package from the customer. The method of providing a customer-selected remote control feature package may further include filling the order for the customer-selected remote control feature package by providing the customer with at least one respective remote transmitter for operating the universal remote control device according to the customer-selected remote control feature package from among a plurality of different remote transmitters for different remote control feature packages.

### FIELD OF THE INVENTION

The present invention relates to the field of remote control systems and, more particularly, to remote control systems for a vehicle.

### BACKGROUND OF THE INVENTION

Vehicle security systems are widely used to deter vehicle theft, prevent theft of valuables from a vehicle, deter vandalism, and to protect vehicle owners and occupants. A typical automobile security system, for example, includes a central processor or controller connected to a plurality of vehicle sensors. The sensors, for example, may detect opening of the trunk, hood, doors, windows, and also movement of the vehicle or within the vehicle. Ultrasonic and microwave motion detectors, vibration sensors, sound discriminators, differential pressure sensors, and switches may also be used as sensors. In addition, radar sensors may be used to monitor the area proximate the vehicle. The controller may also operate to give an alarm indication in the event of triggering of a vehicle sensor. The alarm indication may typically be flashing of the lights and/or sounding of the vehicle horn or a siren. In addition, the vehicle fuel supply and/or ignition power may be selectively disabled based upon an alarm condition.

Modern automobiles typically include a wide assortment of remote control features. Various types of remote control features can be used to both secure the vehicle, and to make vehicle operation more convenient for the user. Typical features may relate to remote keyless entry, such as illustrated in U.S. Pat. No. 6,297,731 to Flick, remote vehicle starting, such as illustrated in U.S. Pat. No. 5,719,551 to Flick, and remote vehicle security arming and disarming, such as illustrated in U.S. Pat. No. 6,243,004 to Flick, the entire disclosures of each of which are incorporated herein by reference. Other features may relate to vehicle tracking, including tracking using a global positioning satellite (GPS), for both security and on-board navigation, as illustrated in U.S. patent application Ser. No. 10/105,676, filed on Mar. 28, 2002 by Flick, the entire disclosure of which is incorporated herein by reference.

Some of the above remote control systems may be included as standard equipment on a particular make or model of a vehicle. More commonly, however, the features are provided by after-market devices, which are installed at the purchaser's request. Typically, it is the dealer, or an independent contractor, that will be called upon to install the requested security or convenience devices after the vehicle has been delivered from the factory to the dealer.

Not all prospective purchasers have identical tastes, and accordingly, not every purchaser will desire the same features in the vehicle. Therefore, to satisfy each customer's particular desire for a specific package of remote control features, a dealer may maintain a large inventory of different types of devices to be able to provide a specifically requested remote control feature package for each particular purchaser. Maintaining a large inventory of different remote control devices, however, may be costly and cumbersome for the dealer.

It is similarly difficult for a dealer to specially install a remote control feature package on a customer-by-customer basis as each vehicle is sold. Thus, to date, dealers have had to attempt to balance the benefits of meeting each customer's particular demand against the costs of maintaining large inventories of different remote control devices and installing different packages of features on a customer-by-customer basis.

One strategy is for the dealer to market vehicles having a particular, pre-installed package of features that is intended to at least approximately correspond to the tastes of the average vehicle purchaser. Of course, since every customer will not necessarily want the same package of features, the dealer will often have to discount those features that a particular customer does not necessarily want. Conversely, the dealer may not be able to fully pass on the cost of inventory maintenance and installation of additional features, not included as part of the basic feature package, but requested by a particular customer.

Accordingly, another strategy is for the dealer to install a universal remote control having a plurality of available feature packages that may be customized on a customer-by-customer basis by wirelessly enabling the customer-selected remote control feature package. Such an advantageous strategy is disclosed in U.S. patent application Ser. No. 10/085,403 filed by Flick on Feb. 28, 2002, the entire disclosure of which is incorporated herein by reference.

### SUMMARY OF THE INVENTION

In view of the foregoing background, it is therefore an object of the present invention to provide an efficient and cost effective method and system for providing customer-selected remote control feature packages in vehicles.

This and other objects, features, and advantages in accordance with the present invention are provided by a method through which a customer may select a remote control feature package in a vehicle. The method may comprise installing, in the vehicle, a universal remote control device operable according to a plurality of different remote control feature packages, and negotiating a sale or lease of the vehicle with a customer. Negotiating the sale or lease of the vehicle may comprise offering the different remote control feature packages to the customer, and accepting an order for the customer-selected remote control feature package from the customer.

The method may further comprise filling the order for the customer-selected remote control feature package by providing the customer with a respective remote transmitter for operating the universal remote control device according to the customer-selected remote control feature package. The respective remote transmitter may be selected from among a plurality of different remote transmitters for different remote control feature packages. Accordingly, the dealer may install a universal device in each vehicle and customize its feature by supplying one of several types of transmitters. Inventory is significantly reduced and the process is much simpler.

The vehicle may comprise a data communications bus, and installing the universal remote control device may comprise connecting the universal remote control device to the data communications bus. The universal remote control device may be settable to the customer-selected remote control feature package based upon signals from the respective remote transmitter for the customer-selected remote control feature package.

The different remote transmitters for the different remote control feature packages may have different prices associated therewith so that a supplier of remote transmitters may receive different revenue for different remote control feature packages. In some embodiments, a vehicle dealer may negotiate the sale or lease of the vehicle, and the universal remote control device may be installed after vehicle delivery to the vehicle dealer. In other embodiments, the universal remote control device may be installed prior to vehicle delivery to the vehicle dealer.

The different remote control feature packages may comprise a keyless entry remote control feature package, a security remote control feature package, and an engine starting remote control feature package, for example. In some embodiments, the keyless entry remote control feature package may also comprise window operating features, and the security remote control feature package may also comprise a vehicle tracking feature.

The universal remote control device may comprise a controller and a receiver connected thereto. Accordingly, the method may further comprise learning the respective remote transmitter for operating the universal remote control device into the controller.

Another aspect of the invention relates to a system for providing a customer-selected remote control feature package in a vehicle. The system may comprise a universal remote control device installed in the vehicle and operable according to a plurality of different remote control feature packages. The system may also include a respective remote transmitter for operating the universal remote control device according to the customer-selected remote control feature package. The respective remote transmitter may be selected from among a plurality of different remote transmitters, each of which correspond to one of the plurality of different remote control feature packages.

### BRIEF DESCRIPTION OF THE DRAWINGS

FIG. 1 is a flow chart illustrating a method of providing a customer-selected remote control feature package according to the present invention.

FIG. 2 is a schematic block diagram of a system for providing a customer-selected remote control feature package according to the present invention.

FIGS. 3-4 are schematic block diagrams of alternate embodiments of the system shown in FIG. 2.

FIG. 5 is a schematic block diagram of the various entities using the system and method in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers are used to indicate like elements, and prime and multiple prime notations are used to indicate similar elements in alternate embodiments.

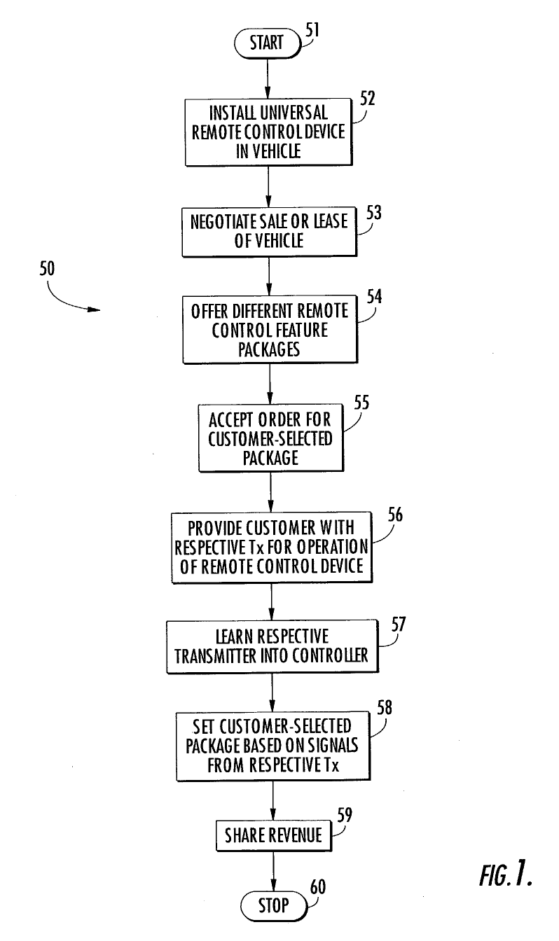

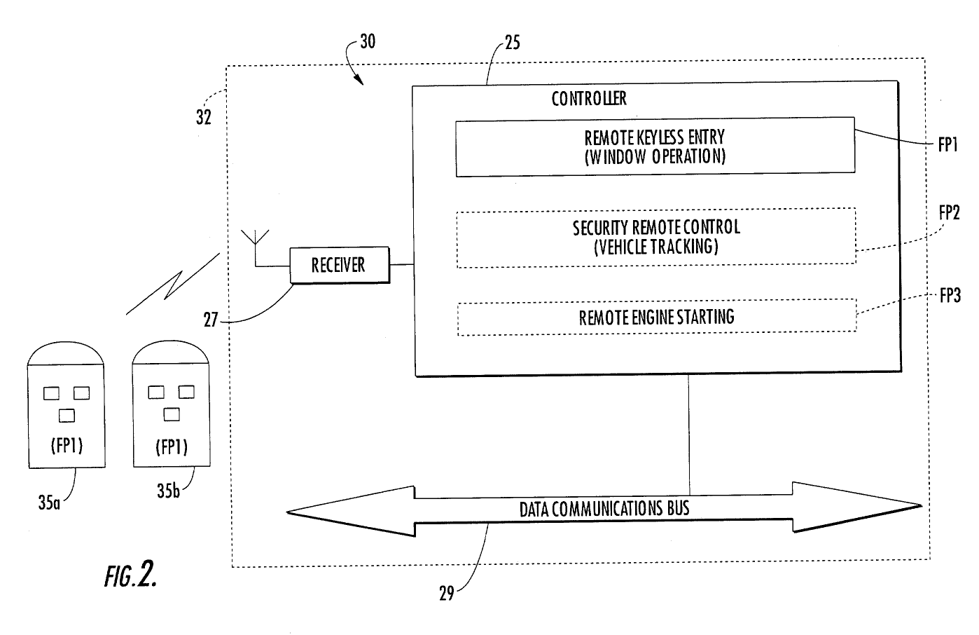

Referring initially to the flowchart 50 and schematic diagram of FIGS. 1 and 2, respectively, providing a customer-selected remote control feature package in a vehicle 32 in accordance with the present invention is now described. From the start (Block 51), a universal remote control device 30 is installed in a vehicle 32 at Block 52. At Block 53, a sale or lease of the vehicle 32 is negotiated. This is typically accomplished at a vehicle dealership. At Block 54, a plurality of different remote control feature packages FP1-FP3 is offered to the customer. In response to the offer, the customer selects one of the plurality of different remote control feature packages FP1-FP3 to define a customer-selected remote control feature package. Accordingly, an order for the customer-selected remote control feature package is accepted at Block 55.

At Block 56, the customer is illustratively provided with a pair of respective remote transmitter 35a, 35b for operation of the universal remote control device 30. The pair of remote transmitters 35a, 35b is learned into a controller 25 of the universal remote control device 30 at Block 57. At Block 58, the customer-selected remote control feature package is set based on signals from the respective remote transmitter 35.

At Block 59, revenue is shared between a supplier of the universal remote control devices 30, which will typically be the same entity that supplies the plurality of different remote transmitters, and the vehicle dealer. More particularly, the plurality of different remote transmitters for the different remote control feature packages FP1-FP3 may have different prices associated therewith. Accordingly, the supplier of the universal remote control devices 30 may receive different revenue for different remote control feature packages FP1-FP3. The method is ended at Block 60.

Turning now more specifically to FIG. 2, the system 15 for providing a customer-selected remote control feature package FP1-FP3 in a vehicle 32 is now described in greater detail. The system 15 illustratively includes the universal remote control device 30. The universal remote control device 30 illustratively includes a controller 25 having a plurality of different remote control feature packages schematically illustrated by the blocks labeled FP1-FP3. The universal remote control device 30 also illustratively includes a receiver 27 for receiving signals from the plurality of different remote transmitters.

The system 15 also illustratively includes a pair of respective remote transmitters 35a, 35b for operating the universal remote control device 30 according to the customer-selected remote control feature package. More specifically, the pair of respective remote transmitters 35a, 35b is selected from among a plurality of different remote transmitters. Each of the plurality of different transmitters corresponds to one of the plurality of different remote control feature packages FP1-FP3. Although a pair of respective remote transmitters 35a, 35b is illustrated, it shall be readily understood by those skilled in the art that any number of remote transmitters may be provided as the respective transmitters corresponding to the customer-selected remote control feature package.

In some embodiments, the vehicle 32 may include a data communications bus 29. In such vehicles, the universal remote control device 30 may advantageously interface to the data communications bus 29. One such remote control device that may advantageously be interfaced to a data communications bus is illustrated in U.S. patent application Ser. No. 09/583,333 filed on May 31, 2000 by Flick, the entire disclosure of which is incorporated herein by reference.

The universal remote control device 30 may be settable to the customer-selected remote control feature package based upon signals from the pair of remote transmitters 35a, 35b for the customer-selected remote control feature package. As previously noted, the customer-selected feature package is selected from among a plurality of different feature packages FP1-FP3. A first one of the remote control feature packages FP1 may, for example, comprise a remote keyless entry (RKE) feature package as shown by the solid line block FP1. In some embodiments, the RKE feature package may include window operating features, such as those disclosed in U.S. patent application Ser. No. 10/316,342, filed on Dec. 11, 2002 by Flick, the entire disclosure of which is incorporated herein by reference.

A second remote control feature package FP2 may, for example, comprise a security remote control feature package. The security remote control feature package FP2 may comprise a vehicle tracking feature, such as based upon a global positioning receiver, or any other type of vehicle tracking system, as understood by those skilled in the art. Of course, conventional arming and disarming may be operated by the remote transmitter. An alarm indication may be generated by a security breach when in the armed mode as will be appreciated by those skilled in the art.

A third remote control feature package FP3 may, for example, comprise an engine starting remote control feature package. This is especially advantageous in colder climates, where a user may wish to remotely start the engine in order to warm up the vehicle before entering it.

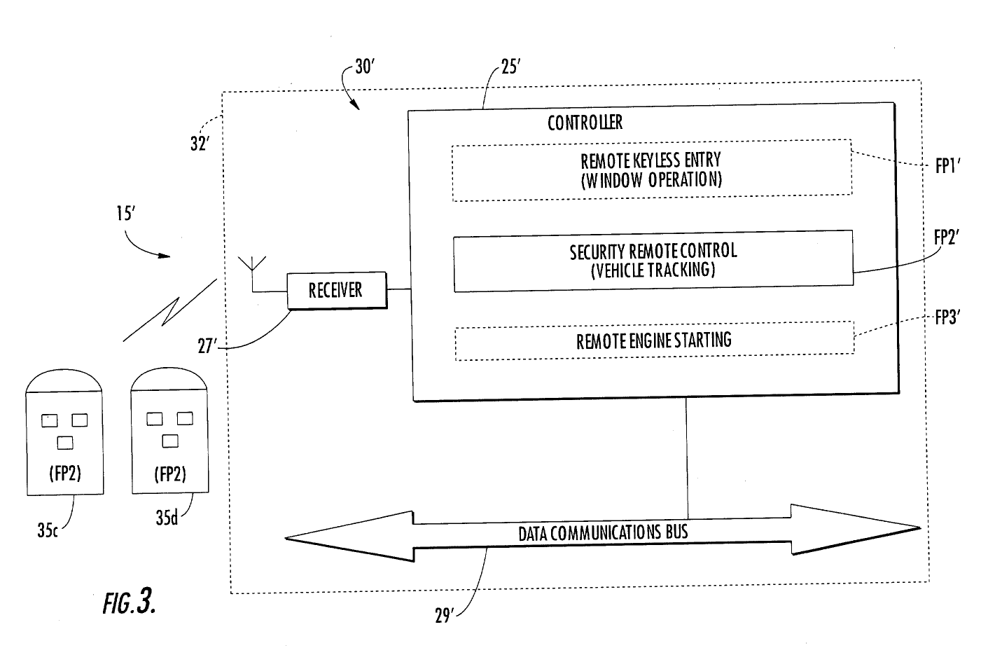

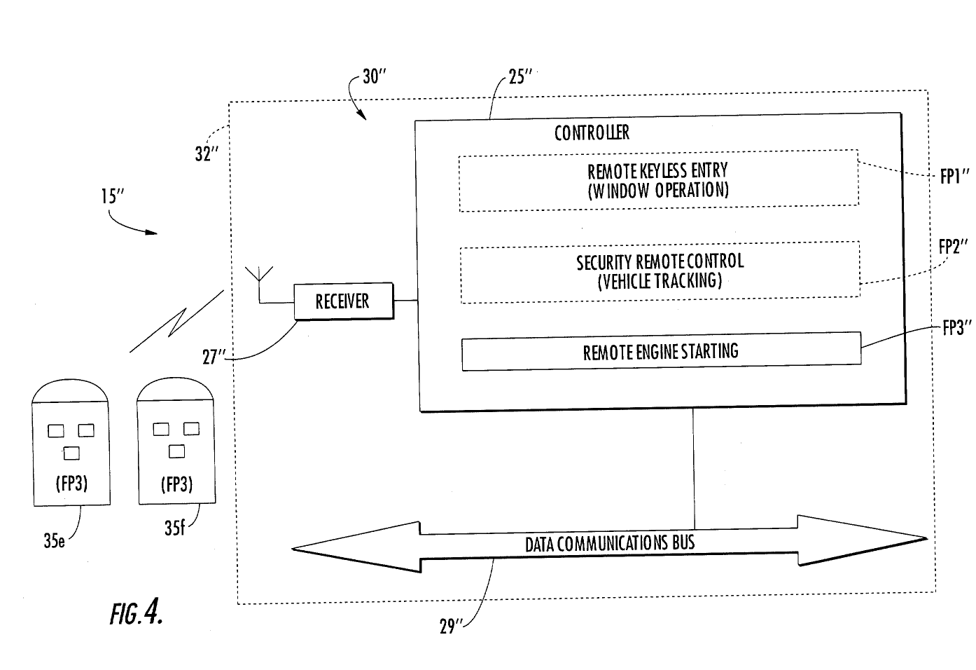

As a brief summary, the system 15 illustrated in FIG. 2 includes a universal remote control device 30 having the RKE feature FP1 as the customer-selected remote control feature package (depicted as the solid line block), and the security feature FP2 and the remote engine starting feature FP3 as those not selected by the customer (depicted as dashed line blocks). Of course, since the remote control device 30 is a universal device, the customer may select others or any combination of the different feature packages FP1-FP3. For example, the security feature package FP2 represents the customer-selected feature package in the embodiment of the system 15′ illustrated in FIG. 3. Accordingly, different remote transmitters 35c, 35d are provided to the customer to operate the universal remote control device 30′ according to the security feature package FP2. The remote engine starting feature FP3 represents the customer-selected feature packages in the embodiment of the system 15″ illustrated in FIG. 4. Again, different remote transmitters 35e, 35f are provided to the customer to operate the universal remote control device 30″ according to the security feature package FP3.

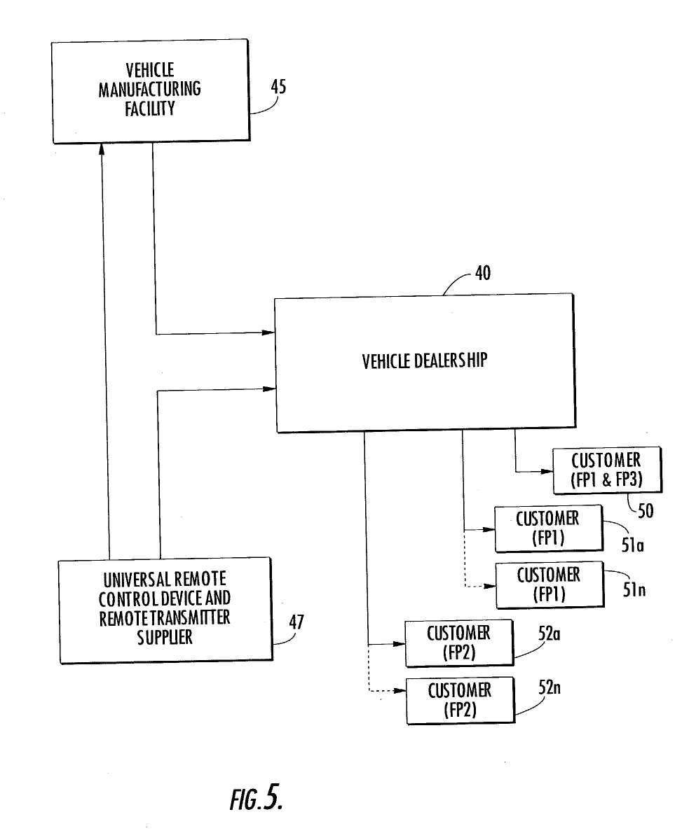

Turning now more specifically to FIG. 5, the system 15 and method for providing a customer-selected remote control feature package is further described. More particularly, a vehicle 32 is typically manufactured in a vehicle manufacturing facility 45 and thereafter delivered to the vehicle dealership 40. A universal remote control device supplier 47 typically supplies the universal remote control devices 30 and the remote transmitters 35a-35f.

The universal remote control device and remote transmitter supplier 47 may illustratively supply the universal remote control devices 30 and the remote transmitters 35a-35f to either the vehicle manufacturing facility 45 so that the universal remote control device may be installed in the vehicle 32 prior to delivery to the vehicle dealership 40 or, in the alternative, to the vehicle dealership, so that the universal remote control device may be installed after delivery of the vehicle to the dealership. Accordingly, the universal remote control device 30 may be a factory installed or an after-market item, as shall be understood by those skilled in the art.

As noted above, the respective transmitters 35a-35f for operating the universal remote control device 30 may be learned into the controller 25. More particularly, the controller 25 may be switched to a learning mode to learn the respective transmitters 35a-35f. Learning of remote transmitters will be readily appreciated by those skilled in the art without requiring further discussion herein.

The vehicle dealership 40 may satisfy the different needs of its customers in an efficient manner and with reduced inventory based upon the present invention. Moreover, the supplier 47 of the remote control equipment can share in revenue from upgraded remote control systems without reliance on difficult accounting schemes, for example. As shown schematically in FIG. 5, some customers 51a-51n may order sets of remote transmitters with the RKE feature set FP1. Other customers 52a-52n may order remote transmitters with the security feature package FP2, etc. Of course, some customers 50 may order sets of transmitters wherein one transmitter has the more limited RKE feature package FP1 and another transmitter has the enhanced remote start package FR3. Alternately, one transmitter may be dominant, that is, learned into specific memory location and is operative to set the feature package for any other learned transmitters. In addition, other combinations and permutations are also contemplated by the present invention.

The universal remote control device 30 installed in a given vehicle can be the same for all vehicles, can be made relatively low cost, and may be readily installed in those embodiments that interface to vehicle devices through the vehicle data communications bus 29 as will be appreciated by those skilled in the art. Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. A method of providing a customer-selected remote control feature package in a vehicle, the method comprising:
installing in the vehicle a universal remote control device operable according to a plurality of different remote control feature packages;
negotiating a sale or lease of the vehicle with a customer and comprising
offering the different remote control feature packages to the customer, and
accepting an order for the customer-selected remote control feature package from the customer; and
filling the order for the customer-selected remote control feature package by providing the customer with at least one respective remote transmitter for operating the universal remote control device according to the customer-selected remote control feature package from among a plurality of different remote transmitters for different remote control feature packages.

2. A method according to claim 1 wherein the vehicle comprises a data communications bus; and wherein installing comprises connecting the universal remote control device to the data communications bus.

3. A method according to claim 1 wherein the universal remote control device is settable to the customer-selected remote control feature package based upon signals from the at least one respective remote transmitter for the customer-selected remote control feature package.

4. A method according to claim 1 wherein the different remote transmitters for the different remote control feature packages have different prices associated therewith so that a supplier of remote transmitters receives different revenue for different remote control feature packages.

5. A method according to claim 1 wherein negotiating is performed by a vehicle dealer; and wherein installing is performed after vehicle delivery to the vehicle dealer.

6. A method according to claim 1 wherein negotiating is performed by a vehicle dealer; and installing is performed prior to vehicle delivery to the vehicle dealer.

7. A method according to claim 1 wherein the different remote control feature packages comprise a keyless entry remote control feature package.

8. A method according to claim 7 wherein the keyless entry remote control feature package further comprises window operating features.

9. A method according to claim 1 wherein the different remote control feature packages comprise a security remote control feature package.

10. A method according to claim 9 wherein the security remote control feature comprises a vehicle tracking feature.

11. A method according to claim 1 wherein the different remote control feature packages comprise an engine starting remote control feature package.

12. A method according to claim 1 wherein the universal remote control device comprises a controller and a receiver connected thereto.

13. A method according to claim 12 further comprising learning the at least one respective remote transmitter for operating the universal remote control device into the controller.

14. A method of providing a customer-selected remote control feature package in a vehicle, the method comprising:
installing in the vehicle a universal remote control device operable according to a plurality of different remote control feature packages; and
providing a customer with at least one respective remote transmitter for operating the universal remote control device according to the customer-selected remote control feature package from among a plurality of different remote transmitters for different remote control feature packages.

15. A method according to claim 14 wherein the vehicle comprises a data communications bus; and wherein installing comprises connecting the universal remote control device to the data communications bus.

16. A method according to claim 14 wherein the universal remote control device is settable to the customer-selected remote control feature package based upon signals from the at least one respective remote transmitter for the customer-selected remote control feature package.

17. A method according to claim 14 wherein the different remote transmitters for the different remote control feature packages have different prices associated therewith so that a supplier of remote transmitters receives different revenue for different remote control feature packages.

18. A method according to claim 14 wherein the different remote control feature packages comprise a keyless entry remote control feature package.

19. A method according to claim 18 wherein the keyless entry remote control feature package further comprises window operating features.

20. A method according to claim 14 wherein the different remote control feature packages comprise a security remote control feature package.

21. A method according to claim 20 wherein the security remote control feature comprises a vehicle tracking feature.

22. A method according to claim 14 wherein the different remote control feature packages comprise an engine starting remote control feature package.

23. A method according to claim 14 wherein the universal remote control device comprises a controller and a receiver connected thereto.

24. A method according to claim 23 further comprising learning the at least one respective remote transmitter for operating the universal remote control device into the controller.

25. A system for providing a selectable remote control feature package in a vehicle, the system comprising:
a universal remote control device installed in the vehicle and operable according to a plurality of different remote control feature packages; and
at least one respective remote transmitter for operating the universal remote control device according to a selected remote control feature package;
said at least one respective remote transmitter being selected from among a plurality of different remote transmitters, each corresponding to one of the plurality of different remote control feature packages.

26. A system according to claim 25 wherein the vehicle comprises a data communications bus; and wherein said universal remote control device interfaces to the data communications bus.

27. A system according to claim 25 wherein said universal remote control device is settable to the selected remote control feature package based upon signals from said at least one respective remote transmitter for the selected remote control feature package.

28. A system according to claim 25 wherein the different remote control feature packages comprise a keyless entry remote control feature package.

29. A system according to claim 28 wherein the keyless entry remote control feature package further comprises window operating features.

30. A system according to claim 25 wherein the different remote control feature packages comprise a security remote control feature package.

31. A system according to claim 30 wherein the security remote control feature comprises a vehicle tracking feature.

32. A system according to claim 25 wherein the different remote control feature packages comprise an engine starting remote control feature package.

33. A system according to claim 25 wherein the universal remote control device comprises a controller and a receiver connected thereto.

34. A system according to claim 33 wherein said at least one respective remote transmitter for operating the universal remote control device is learned into the controller.

35. A system for providing a customer-selected remote control feature package in a vehicle comprising a data communications bus, the system comprising:
a universal remote control device installed in the vehicle to interface with the data communications bus and operable according to a plurality of different remote control feature packages; and
at least one respective remote transmitter for operating the universal remote control device according to the customer-selected remote control feature package;
said at least one respective remote transmitter being selected from among a plurality of different remote transmitters, each corresponding to one of the plurality of different remote control feature packages;
said universal remote control device being settable to the customer-selected remote control feature package based upon signals from said at least one respective remote transmitter for the customer-selected remote control feature package.

36. A system according to claim 35 wherein the plurality of different remote transmitters for the different remote control feature packages have different prices associated therewith so that a supplier of remote transmitters receives different revenue for different remote control feature packages.

37. A system according to claim 35 wherein the different remote control feature packages comprise a keyless entry remote control feature package.

38. A system according to claim 37 wherein the keyless entry remote control feature package further comprises window operating features.

39. A system according to claim 35 wherein the different remote control feature packages comprise a security remote control feature package.

40. A system according to claim 39 wherein the security remote control feature comprises a vehicle tracking feature.

41. A system according to claim 35 wherein the different remote control feature packages comprise an engine starting remote control feature package.

42. A system according to claim 35 wherein the universal remote control device comprises a controller and a receiver connected thereto.

43. A system according to claim 42 wherein said at least one respective remote transmitter for operating the universal remote control device is learned into the controller.
